(19) United States
(12) Patent Application Publication
(10) Pub. No.: US 2012/0056006 A1
(43) Pub. Date: Mar. 8, 2012

(54) Global warming letter

(75) Inventor: David Bendah, San Diego, CA (US)

(73) Assignee: David Bendah, San Diego, CA (US)

(21) Appl. No.: 13/136,465

(22) Filed: Aug. 3, 2011

Related U.S. Application Data
(60) Provisional application No. 61/402,766, filed on Sep. 3, 2010.

(51) Int. Cl. A01G 15/00

(52) U.S. Cl. 239/14.1

(57) ABSTRACT

David Bendah's invention is a method of cooling or lowering the temperature of any matter and making other changes to matter with the use of written microscopic words or seeing-eye legible written words that are distributed on paper, dust or sand granules to various organizations or entities.

The distribution of a letter written on any material including paper, sand and dust, that lowers the temperature, reduces humidity, and reduces disease as well as influences other conditions. The dust or sand material could be dropped on clouds or mixed with powder, soap, wax, lotion, polish, cream, jelly, gel, any liquids, lubricants, glue, water, gases, any solids, stone material, gem stones, diamond, corundum, sapphire, ruby, glass, cement, plaster, fabric, plastics, pens, pencils, soccer balls, ice skates, razor blades or metals including all alloys and the dust or sand can be inserted in air conditioning units, cooling units, ventilation units, fans or other mechanisms.

### SUMMARY

David Bendah purports that upon reading or displaying his written email letter the temperature does lower in degrees and the temperature does become cooler, the humidity is lower and the incidence of disease decreases.

### DRAWINGS

Any material that includes written words including materials like, paper, sand, dust and includes microscopic materials. The dust or sand material could be dropped on clouds or mixed with powder, soap, wax, lotion, polish, cream, jelly, gel, any liquids, lubricants, glue, water, gases, any solids, stone material, gem stones, diamond, corundum, sapphire, ruby, glass, cement, plaster, fabric, plastics, pens, pencils, soccer balls, ice skates, razor blades or metals including all alloys and the dust or sand can be inserted in air conditioning units, cooling units, ventilation units or fans or other mechanisms.

### DRAWING FIGURES

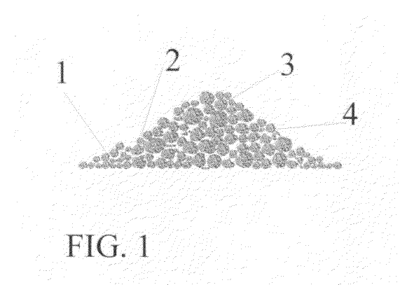

FIG. 1 Displays a small pile of grains of sand and dust.

### DRAWING REFERENCE NUMERALS

1. Miscellaneous sand grain
2. Miscellaneous sand/dust grain
3. Miscellaneous sand/dust grain
4. Miscellaneous sand grain

### DETAILED DESCRIPTION

It is believed that with some type of distribution and circulation of David Bendah's written work in November of 2008 and even later, this caused David Bendah's invention to take effect then thus effect lowering of the temperature in certain parts of the United States and other parts of the world, the letter also influenced other conditions. Enclosed is a copy of the Nov. 24, 2008 email letter that was later expanded on Jul. 22, 2009, The second letter is in this section was the latest version of a letter similar to the Jul. 22, 2009 Global Warming letter.

### FEDERALLY SPONSORED RESEARCH

None.

David Bendah did write federal government agencies (see log) about his own original work but did not receive any feedback regarding his Global Warming Letter.

### SEQUENCE LISTING

Unknown

### Similar Mechanisms

### A Decrease in Temperature

David Bendah's distribution to people who read his email global warming letter is similar to the operation of an air conditioner. An air conditioner alters the climate by lowering the temperature of air making air cooler. David Bendah's “invention the global warming letter process lowers the temperature of air, making air cooler.

### A Reduction of Humidity

David Bendah's distribution to people who read his email global warming letter is also similar to the operation of a humidifier. An humidifier alters the climate by removing water from the air making the air dryer. David Bendah's invention of global warming process makes the air dryer in many ways and at certain times.

### A Reduction in Disease

David Bendah's distribution to people who read his email global warming letter is also similar to the operation of disinfectant. A disinfectant alters environment by removing micro organisms thus making the air, liquids and solids disinfected, so that they lack disease. David Bendah's invention of global warming process makes the air, liquids and solids healthier in many ways and at certain times.

There should be no question in the minds of the patent examiner in granting David Bendah a patent for David Bendah's method of cooling air, decreasing humidity and David Bendah's method of reducing bacteria counts.

### History of the Invention

History of the invention which was an original document not published before the Nov. 24, 2008 date.

The invention was first used on Nov. 24, 2008. and in Nov. 25, 2008 in a letter to David Bendah's brother, Joshua Bendah.

### Copy of Nov. 24, 2008 Email Letter—Letter One.

From David Bendah

To Joshua Bendah

Nov. 24, 2008

Joshua, how is the wife and family. I hear your little daughter Sequoia is one year old. Happy birthday.

I have come to the point in my life where I have made a decision. I have decided to move or visit the north east part of the United States. I am working on moving to Chicago or New York City. I need the exposure of the cold air in my system.

I have lived in San Diego for thirty years. I have wasted some of that time in this warm Californian city. I should have spent more time in the north east. The cold north where it snows and the ground freezes.

I visited you in Hawaii. I didn't like these tropical islands. The tropical climate makes a person feel lazy and slow. I had a muggy feeling when I was there. I think some people develop craziness due that tropical heat. Drug use is more common in south then in the north. I felt more energetic and alert while I used drugs in San Diego. I have to drink a lot of coffee every day to stay alert. Sometimes, I start falling asleep at work during the day if I don't drink coffee. I feel the craving to use something to pep myself up just so that I can work regular hours.

I think the tropical climate turns a person into a hippie. A hippie hates work, lays back and uses drugs. Hippies sprang up during the war in Vietnam. Millions of American soldiers lived in tropical Vietnam. Maybe a tropical climate disease turned people into hippies.

They say psychic phenomena is more common in tropical regions. Some say it is decay from the ground that creates psychic events. People tend to be crazier in Hawaii then in New York.

Decay in the air and ground freezes when it is cold outside. The cold frost kills something. The chilly cold air make a person feel more alert and sane.

I am not suited to tropical climates. I hate warm weather. I don't like cold weather. The skin gets numb and the chilling effect is painful. I need good cold air. A cold frost makes a person feel better and more energetic. I feel lazy when it is warm and energetic when it is cold. The California climate with massive irrigation topped with global warming makes California tropical.

The cold weather has an effect on people of the north. The people in northern colder regions are serious people that are more business oriented. I need that cold exposure. San Diego is tropical city that is better suited for retirees. San Diego borders Mexico and is on the far south east corner of the United States. San Diego has a large ocean port. There are a lot of military personal in San Diego. One of the jokes in San Diego when you are looking out at the ocean is “let's watch the submarine races.” There are spies in San Diego because of the ocean access and border crossing.

I want to better myself so I am exploring the possibility of living in Chicago and New York City.

Take Care

David Bendah

### Copy of Nov. 25, 2008 Email Letter—Letter Two.

Nov. 25, 2008

Correction to my last letter.

From David Bendah

Hi Again Yehoshua.

I shouldn't send you this letter because it might contain heresy. I am not a heretic. The letter I sent you was biased.

Heresy is an introduced change to some system of belief, especially a religion, that conflicts with the previously established canon of that belief. Today, heresy can be without a religious context as the holding of ideas that are in fundamental disagreement with the status quo in any practice and branch of knowledge.

Here are the following corrections:
1. The air conditioning in my car is broken. It hasn't worked for many years. I have to fix it. We rarely use the air conditioning at home. The air conditioning system in my office doesn't work that well. Cold air from an air conditioner really makes the difference. With an air conditioner I can chill a room until I shake. I feel better and I am faster when the air is cold.
2. Some people say that psychic phenomena has saved lives.
3. Drugs are bad.

Here something I wanted to share:
1. You can tell how smart a person is by how much money that person has. People measure a person's intelligence by the amount of money that person has. In our family the smartest of the Bendah brothers would be: 1). Morris. 2). Joshua. 3). David. Morris is the richest so he is the smartest.
2. No one will do anything for you. You will have to do it yourself.
3. I have never met anyone that looks like you or acts like you.
4. You should contact an attorney about getting your American Citizenship papers. Make an appointment with any attorney.
5. Years ago you asked me what a person has to do to make more money. For you the easiest way to make more money is to raise your I.Q. You can raise your I.Q. if you work on this on a regular basis. Put your IQ on a graph. Measure your IQ each week and work on raising your IQ score. Make is a daily goal to increase your IQ score. Had you have done this in the 80's you would have been a multi-millionaire by today's date.

I am enclosing the exact same letter with the above corrections. I am under the impression that accuracy is important.

Joshua Bendah

Nov. 25, 2008

Joshua, how is your wife and family. I hear your little daughter Sequoia is one year old. Happy birthday.

I have come to the point in my life where I have made a decision. I have decided to move or visit the north east part of the United States. I am working on moving to Chicago or New York City. I need the exposure of the cold air in my system.

I have lived in San Diego for thirty years. I have wasted some of that time in this warm Californian city. I should have spent more time in the north east. The cold north where it snows and the ground freezes.

I visited you in Hawaii. I didn't like these tropical islands. The tropical climate makes a person feel lazy and slow. I had a muggy feeling when I was there. I think some people develop craziness due that tropical heat. Drug use is more common in south then in the north. I felt more energetic and alert while I used drugs in San Diego. I have to drink a lot of coffee every day to stay alert. Sometimes, I start falling asleep at work during the day if I don't drink coffee. I feel the craving to use something to pep myself up just so that I can work regular hours. Drugs are bad.

I think the tropical climate turns a person into a hippie. A hippie hates work, lays back and uses drugs. Hippies sprang up during the war in Vietnam. Millions of American soldiers lived in tropical Vietnam. Maybe a tropical climate disease turned people into hippies.

They say psychic phenomena is more common in tropical regions. Some say it is decay from the ground that creates psychic events. People tend to be crazier in Hawaii then in New York. Decay in the air and ground freezes when it is cold outside. The cold frost kills something. The chilly cold air make a person feel more alert and sane.

Some people say that psychic phenomena has saved lives.

I am not suited to tropical climates. I hate warm weather. I don't like cold weather. The skin gets numb and the chilling effect is painful. I need good cold air. A cold frost makes a person feel better and more energetic. I feel lazy when it is warm and energetic when it is cold. The California climate with massive irrigation topped with global warming makes California tropical.

The cold weather has an effect on people of the north. The people in northern colder regions are serious people that are more business oriented. I need that cold exposure. San Diego is tropical city that is better suited for retirees. San Diego borders Mexico and is on the far south east corner of the United States. San Diego has a large ocean port. There are a lot of military personal in San Diego. One of the jokes in San Diego when you are looking out at the ocean is “let's watch the submarine races.” There are spies in San Diego because of the ocean access and border crossing.

Some of this letter is biased. The air conditioning in my car is broken. It hasn't worked for many years. I have to fix it. We rarely use the air conditioning at home. The air conditioning system in my office doesn't work that well. Cold air from an air conditioner really makes the difference. With an air conditioner I can chill a room until I shake. I feel better and I am faster when the air is cold.

I want to better myself so I am exploring the possibility of living in Chicago and New York City

Take Care

David Bendah

### Other Email Letters Mailed in November of 2008

There were three other letters written by David Bendah to other people with no explanation of Global Cooling” but did vaguely mention the climate.
1) One email on Nov. 19, 2008 to Marc
2) One email on Nov. 21, 2008 to Robert
3) One email on Nov. 22, 2008 to Bridget

The use of the invention was accidental. David Bendah was not aware of what the outcome when he first originated the whole cooling concept that was documented in a letter to his brother, Joshua. David Bendah realized that it was the words in his email letter that led to a cooling process all around him. The dates in the sequence of original email letters that were mailed in November of 2008 are as follows.

David Bendah did publish his global warming letter on Nov. 24, 2010 and Nov. 25, 2010 but David Bendah did know the information contained in the global warming letter from the period of time from 1979 to 2010. David Bendah could have authored the same global warming letter during these time periods. David Bendah grew up in Toronto, Canada and did understand the mechanism of cold winter weather from 1962 to 1978, the time period David Bendah lived in Toronto Canada. David Bendah did live in San Diego during the time periods of 1978 to 2010 so David Bendah did understand the mechanisms of a warm southern tropical climate. David Bendah did visit his brother, Joshua Bendah, who lived in Hawaii in 1996 and did understand the mechanism of a warm, tropical, humid climate. David Bendah did study the climate mechanism of Vietnam and Panama and mountain climates without actually visiting those countries.

David Bendah did also visit on vacation Miami, Florida at about 1976. David Bendah also did visit Cancun, Mexico at about 1985 and Mazatlan, Mexico several times during the 1980's.

### Nov. 24, 2008—Letter One

“Letter without the Introduction”

Joshua Bendah

Nov. 25, 2008

Joshua, how is your wife and family. I hear your little daughter Sequoia is one year old. Happy birthday.

I have come to the point in my life where I have made a decision. I have decided to move or visit the north east part of the United States. I am working on moving to Chicago or New York City. I need the exposure of the cold air in my system.

I have lived in San Diego for thirty years. I have wasted some of that time in this warm Californian city. I should have spent more time in the north east. The cold north where it snows and the ground freezes.

I visited you in Hawaii. I didn't like these tropical islands. The tropical climate makes a person feel lazy and slow. I had a muggy feeling when I was there. I think some people develop craziness due that tropical heat. Drug use is more common in south then in the north. I felt more energetic and alert while I used drugs in San Diego. I have to drink a lot of coffee every day to stay alert. Sometimes, I start falling asleep at work during the day if I don't drink coffee. I feel the craving to use something to pep myself up just so that I can work regular hours. Drugs are bad.

I think the tropical climate turns a person into a hippie. A hippie hates work, lays back and uses drugs. Hippies sprang up during the war in Vietnam. Millions of American soldiers lived in tropical Vietnam. Maybe a tropical climate disease turned people into hippies.

They say psychic phenomena is more common in tropical regions. Some say it is decay from the ground that creates psychic events. People tend to be crazier in Hawaii then in New York. Decay in the air and ground freezes when it is cold outside. The cold frost kills something. The chilly cold air make a person feel more alert and sane.

Some people say that psychic phenomena has saved lives.

I am not suited to tropical climates. I hate warm weather. I don't like cold weather. The skin gets numb and the chilling effect is painful. I need good cold air. A cold frost makes a person feel better and more energetic. I feel lazy when it is warm and energetic when it is cold. The California climate with massive irrigation topped with global warming makes California tropical.

The cold weather has an effect on people of the north. The people in northern colder regions are serious people that are more business oriented. I need that cold exposure. San Diego is tropical city that is better suited for retirees. San Diego borders Mexico and is on the far south east corner of the United States. San Diego has a large ocean port. There are a lot of military personal in San Diego. One of the jokes in San Diego when you are looking out at the ocean is “let's watch the submarine races.” There are spies in San Diego because of the ocean access and border crossing.

Some of this letter is biased. The air conditioning in my car is broken. It hasn't worked for many years. I have to fix it. We rarely use the air conditioning at home. The air conditioning system in my office doesn't work that well. Cold air from an air conditioner really makes the difference. With an air conditioner I can chill a room until I shake. I feel better and I am faster when the air is cold.

I want to better myself so I am exploring the possibility of living in Chicago and New York City.

Take Care

David Bendah

### Aug. 26, 2010 Letter—Letter Two

### The Global Warming Letter David Bendah Mailed

David Bendah

914 E. 8^{th} Street, Suite 111

National City, Calif. 91950-2564

(619) 474-9200

Oct. 23, 2009

Department Of Energy

1000 Independence Ave., SW

Washington, D.C. 20585

To Whom It May Concern

Please only contact me if you can help me financially. I need money. I am a poor American. I could use any grant, award or prize or even any diploma that is being offered for my contribution to global warming which in part is this “rain dance” letter.

This dated letter is a revised letter in comparison to the previous letters that I have sent out.

The letter I am enclosing a similar but much longer email letter that was dated Nov. 24, 2008 that I sent my brother who lives in Toronto, Canada. A second very similar email letter was sent on Nov. 25, 2008. The information in the enclosed email letter is very good. My explanations are to the point. When reading this email letter please pay attention to the wording for 1 have summarized complicated concepts.

“Watch the temperature outside?” Here is a variation of the email letter I sent my brother.

THE ENCLOSED EMAIL LETTER “It's too hot in the south.”

Joshua Bendah

Nov. 25, 2008

Joshua, how is your wife and family. I hear your little daughter Sequoia is one year old. Happy birthday.

I have come to the point in my life where I have made a decision. It has taken me many years to make this decision. I have finally decided.

I have decided to move or visit the north east part of the United States.

I must. I must.

I am working on moving to the cold north. I am considering Chicago or New York City. It is for the cold air. Just the cold. I need the exposure of the cold air in my system. I need that cold air that we used to get living in Toronto. I need snow flakes piling on my head. I need ice freezing my toes. I need the cold.

I have lived in San Diego for thirty years. It is so beautiful here. It is so warm. The sun is always shinning. The weather is so splendid. It is always green all year in this warm California city that harbors orange trees San Diego is a tropical paradise with tall palm trees and a deep blue ocean. Surfing is all year but in the winter the cold ocean dictates an insulated wet suit for ocean swimming. But sunbathing on the beach sand is all year long.

I have wasted time in this warm southern California city. I should have spent more time in the north east where it is colder. I need a cold city where sometimes when I look up in the winter I will see falling snow flakes. Where I see frost glaze the city. I'm talking about the cold north where it snows and the ground freezes and water is ice. I hate the cold but I need the cold air.

I have been to warmest states. I visited you in Hawaii. I didn't like those tropical islands. I was so sluggish there. There is something wrong with the south. Hawaii is light and lazy. It is tropical. Some of the people there do drugs then they sit around. It is the tropical climate makes a person feel lazy and slow. I had a muggy feeling when I was in Hawaii. I didn't like the humidity. I think some people develop craziness due that tropical heat. They are slower. They are dumber. Drug use is more common in south then in the north. Some feel more energetic and alert with drugs, but drugs also make a person feel worse. I live in the south. The drugs I use contain caffeine. Most of the time it is coffee. I have to drink a lot of coffee every day to stay alert. It is hard to stay awake and alert sometimes. Hot coffee with sugary donuts that are a favorite of some cops is good.

Sometimes, I start falling asleep at work during the day if I don't drink coffee. I feel the craving to use something to pep myself up just so that I can work regular hours. Drugs are awful. Sometimes they make you feel good but other times they make you slow, nervous and unable to think. “Why am I using these drugs”, many users must whine outloud?

It is different in the south. Tropical diseases only originate in the tropics. You don't get Malaria or Yellow fever or the sleeping sickness in the north. Could you imagine the siesta sleeping sickness? The microbes in the south live in the dirt and in the air. You breathe them and you step on them, not to mention these microbes live in your body. It is the heat that incubates these diseases. I don't want these bad micro parasites.

The Panama Canal project partly during the Roosevelt administration is a good example of an American project that had abundant tropical diseases. Many American's gave their lives to the Panama tropical diseases. They needed cold air in Panama. They should have shipped cold air conditioners to the swamps. Who needs this marsh construction the soldiers must have yelled.

You need the frost to fill the soil and the air. When the temperature is cold the disease bugs die. Parasites hate the cold. The freezing north keeps a person healthy. Freezing the ground and the air cures common tropical sickness. Sitting in a freezer should be therapeutic. What a joke, that you would be led to a freezer when you go to the hospital. That would be frost therapy.

I think the tropical climate turns a person into a hippie. A hippie hates work, lays back and uses drugs. Hippies sprang up during the war in Vietnam. Millions of American soldiers lived in tropical Vietnam. Maybe a tropical climate disease turned people into hippies. Why subject us to mildewy tropical heat they must have shouted. You could cure a hippie with a freezing air conditioner.

There is something different about the southern people. They are different because of the tropical climate. Who knows, maybe tumors grow in some people's heads when they live in the south. This could make a person in the south slow. Could you imagine these tumors speaking? Voices in a person's head would be in the south. You couldn't argue with another person in your head, but be nice and agreeable. What a crazy theory. The people in the north might find this hysterical, for they have actual friends where some people in the south talk to themselves. This is an uproar. This would make the people from the north like Toronto and New York even sane. Ha, ha, ha.

The southerners talk more then the north. It is chatter and gossip. It is the south that talks and the north that is silent. I hate loquacious people, not even when I want to know something or anything. The tropical climate is for party fun. They work then study in the north. What bores? They work then play in the south.

I need the cold air. I need to live in the cold north. I need to see snow in the winter. I want to live in a snowy place where it is cold in the winter. But I hate the cold. I need to be in a heated room I always shout when I am outside in the frost. I hate the cold. It feels bad being outside in the cold. I always get sick when it is unusually cold outside. The cold is bad.

A good vacation is always to the south where the skin tans and where the days are lengthened by the sun.

The sun is different in the south. The southern sun removes depression, not to mention the warm air makes a person happy but, being poor leads to depression. Who wants to be poor? The cold air makes a person rich. The richest countries are in the north and the poorest countries are in the south. “How unfair” any country in the south would scream. But what about industry. The steel industry suffers in the south where it is warm. You need cold air to make good steel. Why pain the south, the northern steel mills would shout. They don't manufacture automobiles in the south. It's northern Europe, northern Asia and northern, North America where they fabricate automobiles. Only the best car manufacturers make cars when the winter time of the year has snow on ground.

Not only that but when a country from the north invades a country from the south. The smarter country is the north. The south could have never won the American civil war. A northern army always did better. It was the cold air. If the southern people lived in the north, they could have won the war. How unfair that we live in the south the southerners must have screamed to the north.

What do you do when you want it colder? When a house is built one room is specially insulated so that a home office can be run in this room and beef cuts can be frozen in this same room. A cold frosty room for intellects. Could you imagine people in the south sitting in freezers to become smarter? Ice skating could be the sport of the smart with snow skiing an intellectual sport. Ha ha, could you imagine that.

The northerners have a higher IQ then the south, so they make more money. The northern people are rich. How unfair.

What about higher education? The best schools should be in the north. The Ivy League colleges like Harvard and Yale are located in the north. They need to be north. Farther north is where the Ivy Leagues will end up if it gets warmer. They will holler this school chant as they are learning in the snow.

All southern schools will make cold air conditioning mandatory.

Going to the best colleges will mean learning in the north. What a shame who wants to go to a cold school where, you have to stay indoors in the winter. The northern winter is freezing. The best party colleges are in the south. It would be all work with little play in the boring northern schools. How ridiculous to necessitate snow for higher learning. It's frigid education at it's best, the professors would yell.

If global warming continues then they might move the capitol from Washington D.C. to Maine. Even the capitol is too far south. A southern capitol might be suitable if it is on a cold tall mount. Most countries have a northern capitol.

Global warming affects Canada and the United States. If North America were one country, where would the capitol be, when Washington is too far south? If it were in Montreal, Canada, they could add French to their product labels. Ha ha ha, could you imagine that, not.

Let's face it the cold is bad. Sometimes the snow just piles up. Some of the wind blown swells could be three feet deep. You can't walk on them or you sink into the snow hills, even the cars can't drive. It is hard to move. Shovel this snow the north would shout. I hate blizzards. They could make a person mad. Severe cold is bad.

It was only 1953 when any person was able to climb to negative thirty Fahrenheit degree, peak of Mount Everest. This is ice chilling cold. I would utterly hate to climb any mountain. They must have many frozen corpses stuck to the side of the mountain. I hate the harsh cold not to mention the lack of oxygen on a mountain. That's the frozen Himalayas. Why would an Olympic athlete want to train in the cold mountains, where there is snow? That's stupid. It is too cold besides it is hard to breathe on a mountain, they would yodel loudly from the cliffs

If this mountaineering were a trend for the cold, it would ruin worthless, mountain real estate. Why build an office on the stony face of the mountain. A business might locate on a hill for the freezing cold, why do this. This is crazy. Just use a cold air conditioner to run a business in the heat.

I hate freezing. I enjoy the warm air to the cool air. A vacation is traveling a warm tourist place with palm trees and beaches. The warm tropical climate has benefits. The warm climate is therapeutic. It can make an old person young. It could remedy northern ills. What about the unknown in the warmer regions?

They say the tropics are spiritual.

They say psychic phenomena is more common in tropical regions. Some say it is decay from the ground that creates psychic events. People tend to be crazier in Hawaii then in New York. Decay in the air and the ground freezes when it is cold outside. The cold frost kills something. What is frozen could be in the soil or in the air. It could be everywhere. The chilly cold air makes a person feel more alert and sane. The cold air stops psychic phenomena.

Psychic phenomena is usually divided into four different kinds. One—telepathy, two—clairvoyance, three—precognition and last, the strangest of all, four—psychokinesis.

Some people say that psychic phenomena has saved lives. This sure would be weird.

I am not suited to tropical climates. I hate warm humid weather. I feel muggy and slow when it hot outside. I don't like very humid warm weather. I need the crisp cold air. I don't mind wearing a winter coat or a sweater. I can put a hat on my head when it is cold outside.

Let's be honest. I hate the cold temperature. I hate shaking and feeling cold. I get a runny nose in the cold. It makes a paper tissue soggy. I hate blowing my nose just so I can breathe. The cold winter makes anyone sick. The flu is terrible. I don't like cold weather. I need cold air.

The harsh cold sometimes has a bad effect on my body. It stiffens my muscles. It is harder to walk or even move in the deep cold. I hate it when my fingers and toes are cold and numb. My fingers hurt when they are freezing. My skin gets numb and the chilling effect is painful. The cold chill is so painful. Who likes frost? The cold is terrible. I need to move to the tropical south, I would scream.

But regardless of how bad it is, cold air is good. A cold frost makes a person feel better and more energetic. It numbs the face and skin but later you feel better. I need the cold air. I feel lazy when it is warm but energetic when it is cold. The California climate with massive humidity partly from irrigation topped with global warming makes California tropical. Tropical air breeds tropical microbes. Who needs to be sick? It has gotten more tropical in California over the years. I hope it doesn't become a Hawaii.

Let me be fair. It is so hot while I am writing this. It is hot in this small California office. This is so unusual for November, but the sun through the front windows creates a greenhouse effect. It heats up the front where I am sitting. It is just hot here. The heat is annoying. I don't like the heat. It is the heat in my office that is inspiring this bad letter.

I must add a new section to this letter. I should. I should. I apologize for a biased letter. It sounds like I hate the heat. Here are my extenuating circumstances. The air conditioning in my car is broken. It hasn't worked for many years. I have to fix it. We rarely use the air conditioning at home. The air conditioning system in my office doesn't work that well. I need to fix my car air conditioning system as well as my office air conditioners. I must. I must. I need to make sure my air conditioners are working perfectly.

The cool air is good. Cold air from an air conditioner really makes the difference. With an air conditioner I can chill a room until I shake. I feel better and I am faster when the air is cold.

I know the cold air is good, the cold weather has an effect on people of the north. The people in northern colder regions are serious people that are more business oriented. Some of the smartest people in the world. live in New York City, that has the largest collection of skyscrapers in the world. New York is cold. Cold air can make anyone smart. A southerner that moves to the north becomes smarter. If I want to earn more money I must move north. The cold north.

New York has the cold air. I need that cold exposure. San Diego is a tropical city that is better suited for retirees. San Diego borders Mexico and is on the far south east corner of the United States. San Diego has a large ocean port. There are a lot of military personal in San Diego. One of the jokes in San Diego when you are looking out at the ocean is “let's watch the submarine races.” There are spies in San Diego because of the ocean access and border crossing.

I am looking for ways to increase my income. I need to make more money. I am poor. I would take any good offer. I wonder what jobs I could get? I would like to sell products. I want to better myself so I am exploring the possibility of moving. I have to. I have to.

I want to move to better industries. I need more money opportunities. I want to move to the north. The north where it is cold in the winter. I need the cold air with the snow falling on my face. I need the cold air to make money. I need the cold.

I would like to live in Chicago or New York City.

Take Care

David Bendah

d/10+@2010 David Bendah

914 E 8^{th} Street, Suite 111, National City, Calif. 91950-2564 (619) 474-9200

### Bendah's Post November 2008 Efforts

David Bendah excited about his contribution to global warming in late November of 2008 and early 2009. David Bendah expected a government official to congratulate him with an award or prize. No one from the US government contacted David Bendah in mid 2009. In Feb. 17, 2009 the United States Postal Service did file a Cease And Desist to shut down David Bendah's mail order book business. David Bendah was left with no income after shutting down his office. In May of 2009 the State Of California froze all of David Bendah's bank accounts after accepting a payment agreement for installments for back taxes. At a later date the bank accounts were released by the State Of California. No one in the US government seemed aware of the marvelous endeavor David Bendah had done for Global Warming. The US government might even profit upwards of a trillion dollars as opposed to losing billions of dollars due to Global Warming. No one from the US government sought to congratulate or award David Bendah an award or prize for his efforts to solve global warming. In Jul. 22 of 2009, David Bendah wrote the US government, companies and organizations on behalf of David Bendah's contribution to Global Warming. Here is a list of every organization David Bendah wrote explaining his contribution to counteracting global warming by David Bendah's invention that involves cooling and other improvements.

TABLE OF ORGANIZATIONS THE RECEIVED
DAVID BENDAH'S GLOBAL WARMING LETTER.

| Num. | Address | Letters |
|---|---|---|
| 1 | Nobel Prize, Nobel Web AB, PO Box 5232, SE 102 45, Stockholm, Sweden | 4 |
| | (email and three letters) (Email-Jul. 22, 2009) & Letters - (Jul. 22, 2009) & (Jul. 25, 2009) & | |
| | (Sep. 08, 2009) | |
| 2 | Small Business Administration, 409 3^{rd} Street, SW, Ste 7800, Washington, DC | 1 |
| | 20416 (Jul. 22, 2009) | |
| 3 | Princeton University, Princeton, NJ 08544 (Jul. 22, 2009) & (Jul. 25, 2009) | 2 |
| 4 | Department Of The Interior, 1849 C Street, NW, Washington, DC 20240 | 1 |
| | (Jul. 22, 2009) | |
| 5 | Yale University, New Haven, CT 06520 (Jul. 22, 2009) | 1 |
| 6 | Harvard University, Cambridge, MA 02138 (Jul. 22, 2009) | 1 |
| 7 | NASA, 300 E Street, SW, Washington, DC 20546. (Jul. 25, 2009) & (Jul. 23, 2010) | 2 |
| 8 | Department Of Agriculture, 1400 Independence Ave, SW, Washington, DC 20250 | 1 |
| | (Jul. 30, 2009) | |
| 9 | Department Of Energy, 1000 Independence Ave, SW Washington, DC 20585 | 1 |
| | (Aug.14, 2009) | |
| 10 | Cornell University, Ithaca, NY 14853 (Jul. 25, 2009) | 1 |
| 11 | US Department Of Education, 400 Maryland Ave, SW, Washington, DC 20202 | 1 |
| | (Jul. 30, 2009) | |
| 12 | US Fish And Wildlife Service, 4401 North Fairfax Drive, Arlington, VA 22203 | 1 |
| | (Aug.14, 2009) | |
| 13 | National Endowment. For The Arts, 1100 Pennsylvania Ave, NW Washington, | 1 |
| | DC 20506 (Sep. 01, 2009) | |
| 14 | Dartmouth College, Hanover, NH 03755 (Jul. 30, 2009) | 1 |
| 15 | University Of Pennsylvania, Philadelphia, PA 19104 (Jul. 30, 2009) | 1 |
| 16 | Columbia University, New York City, NY 10027 (Aug. 07, 2009) | 1 |
| 17 | Microsoft Corporation, One Microsoft Way, Redmond, WA 98052 (Sep. 08, 2009) | 1 |
| 18 | Coca-Cola Company, 1 Coca-Cola Plaza, Atlanta, GA 30313. (Aug.14, 2009) | 1 |
| 19 | World Tourism Organization, Capitan Hava 42, Madrid Spain, 28020 (Aug. 04, 2009) | 1 |
| 20 | Food & Agriculture Organization, Viale delle Terme di Caracalla, Rome, Italy | 1 |
| | 00100 (Aug. 04, 2009) | |
| 21 | United Nations Educational Scientific, 7 Place de Fontenoy, 75352, Paris 07 SP | 1 |
| | FRANCE (Aug. 04, 2009) | |
| 22 | World Health Organization, Avenue Appia 20, CH-1211, Geneva 27, Switzerland | 1 |
| | (Aug. 04, 2009) | |
| 23 | Stanford University, Stanford, CA 94305 (Aug. 07, 2009) | 1 |
| 24 | University Of Texas, Austin, TX 78712 (Aug. 07, 2009) | 1 |
| 25 | University Of Michigan, Ann Arbor, MI 48109 (Aug. 07, 2009) | 1 |
| 26 | University Of Illinois - Urbana Champaign, Champaign, IL, 61820 (Aug. 07, 2009) | 1 |
| 27 | University Of Chicago, Chicago, IL 60637 (Aug. 07, 2009) | 1 |
| 28 | Indiana University, Bloomington, Bloomington, IN 47405 (Aug. 07, 2009) | 1 |
| 29 | University Of Wisconsin, Madison, WI 53706 (Aug. 07, 2009) | 1 |
| 30 | Toyota Zaidan, Shinjuku Mitsui Bldg 37f, 2-1-1, Nishi Shinjuku, Shinjuku-ku, | 1 |
| | Tokyo, JAPAN 163-0437- (Email - Aug. 17, 2009) | |
| 31 | PepsiCo Inc, 700 Anderson Road, Purchase, NY 10577 (Sep. 01, 2009) | 1 |
| 32 | Cadbury Schweppes Pic, 25 Berkely Square, London, United Kingdom, W1J 6HB | 1 |
| | (Sep. 01, 2009) | |
| 33 | University Of Alaska, Anchorage, AK 99508 (Sep. 01, 2009) | 1 |
| 34 | Altria Group Inc, Philip Morris, 120 Park Ave, New York City, NY 10017 | 1 |
| | (Sep. 01, 2009) or (Sep. 08, 2009) | |
| 35 | Akinnumi Joshua, Christian Overcomers, 35 Oluwagbebe Street, | 1 |
| | Ologunfed/Shasha - Akowowonjo, Logos State, Nigeria (Oct. 23, 2009) | |
| 36 | Apple Computer Inc., 1 Infinite Loop, Cupertino, CA 95014 (Dec. 09, 2009) | 1 |
| 37 | AT&T Inc., 175 E. Houston, San Antonio, TX 78205 (Dec. 09, 2009) New Address: | 1 |
| | AT&T Inc., 208 S Akard Street, Dallas, TX 75202. | |
| 38 | McDonalds Corporation, McDonalds Plaza, Oak Brook, IL 60523 (Dec. 09, 2009) | 1 |
| 39 | Domino's Pizza LLC, 30 Frank Lloyd Wright Dr., PO Box 997, Ann Arbor, MI | 1 |
| | 48106 (Dec. 09, 2009) | |
| 40 | Hewlett Packard Company, 3000 Hanover Street, Palo Alto, CA 94304 | 1 |
| | (Dec. 09, 2009) | |
| 41 | Molson Coors Brewing Company, 1225 17^{th} Street, Denver, CO 80202 | 1 |
| | (Dec. 09, 2009) | |
| 42 | Exxon/Mobil Corporation, 5959 Las Colinas Blvd, Irving, TX 75039 (Jan. 14, 2010) | 1 |
| 43 | International Business Machines, One New Orchard Rd, Armonk, NY 10504 | 1 |
| | (Jan. 14, 2010) | |
| 44 | Chevron Corporation, 6001 Bollinger Canyon Road, San Ramon, CA 94583 | 1 |
| | (Jan. 14, 2010) | |
| 45 | Ford Motor Company, 1 American Road, Dearborn, MI 48126 (Jan. 14, 2010) | 1 |
| 46 | ConocoPhillips Co, 600 N Dairy Ashford Rd, PO Box 2197, Houston, TX 77079 | 1 |
| | (Jan. 14, 2010) | |
| 47 | National Oceanic and atmospheric Administration, 14^{th} & Constitution Ave, NW, | 1 |
| | Washington, DC 20230. (Jun. 01, 2010) | |
| 48 | National Science Foundation, 4201 Wilson Blvd., Arlington, VA 22230. | 1 |
| | (Jun. 01, 2010) | |
| 49 | Environmental Protection Agency, 1200 Pennsylvania Ave, NW, Washington, DC | 1 |
| | 20460. (Jun. 01, 2010) | |
| 50 | Department Of Transportation, 1200 New Jersey Ave, SW, Washington, DC | 1 |
| | 20590. (Jun. 01, 2010) | |
| 51 | Department Of Housing And Urban Development, 451 7^{th} Avenue, SW, | 1 |
| | Washington, DC 20410. (Jun. 01, 2010) | |
| 52 | Department Of Commerce, 1401 Constitution Ave, NW Washington, DC 20230. | 1 |
| | (Jun. 01, 2010) | |
| 53 | US Agency For International Development, 1300 Pennsylvania Ave, NW | 1 |
| | Washington, DC 20523. (Jun. 03, 2010) | |
| 54 | Bureau For Economic Analysis, 1441 L Street, NW, Washington, DC 20005. | 1 |
| | (Jun. 03, 2010) | |
| 55 | National Archive And Record Administration, 8601 Adelphi Road, College Park, | 1 |
| | MD 20640-6001. (Jun. 03, 2010) | |
| 56 | Department Of Health And Human Services, 200 Independence Avenue, SW, | 1 |
| | Washington, DC 20201. (Jun. 03, 2010) | |
| 57 | Department Of Veteran Affairs, 810 Vermont Avenue, NW, Washington, DC | 1 |
| | 20420. (Jun. 03, 2010) | |
| 58 | General Services Administration, 1800 F Street, NW, Washington, DC 20405. | 1 |
| | (Jun. 03, 2010) | |
| 59 | National Park Service, 1849 C Street, NW, Washington, DC 20240. (Jun. 03, 2010) | 1 |
| 60 | Department Of Justice, 950 Pennsylvania Ave, NW, Washington, DC 20530. | 1 |
| | (Jun. 16, 2010) | |
| 61 | U.S. Postal Service, 475 L'Enfant Plaza SW, Washington, DC 20260-2200. | 1 |
| | (Jun. 16, 2010) | |
| 62 | Department Of The Treasury, 1500 Pennsylvania Avenue, NW, Washington, DC | 1 |
| | 20220. (Jun. 16, 2010) | |
| 63 | U.S. Geological Survey, 12201 Sunrise Valley Drive, Reston, VA 20192. | 1 |
| | (Jun. 16, 2010) | |
| 64 | Wal-Mart Stores Inc., 702 SW 8^{th} Street, Bentonville, AR 72716. (Jun. 16, 2010) | 1 |
| 65 | General Electric Company, 3135 Easton Tpke, Fairfield, CT 06828. (Jun. 16, 2010) | 1 |
| 66 | General Motors Company, 300 Renaissance Ctr, Detroit, MI 48265. (Jun. 25, 2010) | 1 |
| 67 | Farm Credit Administration, 1501 Farm Credit Drive, McLean, VA 22102. | 1 |
| | (Jun. 25, 2010) | |
| 68 | Federal Maritime Commission, 800 N Capitol Street, NW, Washington, DC | 1 |
| | 20579. (Jun. 25, 2010) | |
| 69 | Johnson & Johnson, 1 Johnson & Johnson Plaza, New Brunswick, NJ 08933. | 1 |
| | (Jun. 25, 2010) | |
| 70 | Proctor & Gamble Co., 1 Proctor Gamble Plaza, Cincinnati, OH 45202. | 1 |
| | (Jun. 25, 2010) | |
| 71 | Berkshire Hathaway Inc., 3555 Farnan Street, Suite 1440, Omaha, NE 68131. | 1 |
| | (Jun. 25, 2010) | |
| 72 | National Endowment For The Humanities, 1100 Pennsylvania Avenue, NW, | 1 |
| | Washington, DC 20506. (Jun. 25, 2010) | |
| 73 | Japan Foundation Center, Believe Shinjuku 4F, 1-26-9 Shinjuku, Shinjuku-ku, | 2 |
| | Tokyo, Japan, 160-0022. (Two letters on Jul. 07, 2010) | |
| 74 | Economic Research Service, 1800 M Street, NW, Washington, DC 20036. | 1 |
| | (Jul. 07, 2010) | |
| 75 | Forest Service, 1400 Independence Ave, SW, Washington, DC 20250. | 1 |
| | (Jul. 07, 2010) | |
| 76 | Office Of Scientific & Technical Information, 1 Science.gov Way, Oak Ridge, TN | 1 |
| | 37830. (Jul. 07, 2010) | |
| 77 | Morgan Stanley, 1585 Broadway, New York, NY 10038. (Jul. 07, 2010) | 1 |
| 78 | Duke University, Durham, NC 27708-0586. (Jul. 23, 2010) | 1 |
| 79 | Ohio State University, Columbus, OH 43210. (Jul. 23, 2010) | 1 |
| 80 | University Of Minnesota, Twin Cities Campus, Minneapolis, MN 56716. | 1 |
| | (Jul. 23, 2010) | |
| 81 | John Hopkins University, Baltimore, MD 21218. (Jul. 23, 2010) | 1 |
| 82 | AT&T Inc., 208 S Akard Street, Dallas, TX 75202. (Jul. 23, 2010) | 1 |
| 83 | Environment Canada, 351 St Joseph Boulevard, Place Vincent Massey, 8th Floor, | 1 |
| | Gatineau, Quebec, K1A 0H3, CANADA. (Jul. 23, 2010) | |
| 84 | World Intellectual Property Org. (WIPO), 34 Chemin des Colombettes, CH-1211, | 1 |
| | Geneva 20, SWITZERLAND. (Aug. 10, 2010) | |
| 85 | United Nations Industrial Development Org. (UNIDO), Vienna Intl. Center, PO | 1 |
| | Box 300, Wagram, Wagramerstr. 5, A-1400 Vienna, AUSTRIA. (Aug. 10, 2010) | |
| 86 | Hawaii County Economic Opportunity Council, 47 Rainbow Drive, Hilo, HI | 1 |
| | 96720. (Aug. 10, 2010) | |
| 87 | Department Of State, 2201 C Street NW, Washington, DC 20520. (Aug. 10, 2010) | 1 |
| 88 | Department Of Defense, 1400 Defense Pentagon, Washington, DC 20301. | 1 |
| | (Aug. 10, 2010) | |
| 89 | Tribune Company, 435 N Michigan Avenue, Chicago, IL 60611. (Aug. 10, 2010) | 1 |
| 90 | International Monetary Fund (IMF), 700 19^{th} Street NW, Washington, DC 20431. | 1 |
| | (Aug. 26, 2010) | |
| 91 | International Maritime Organization, 4 Albert Embankment, London, SE1-7SF, | 1 |
| | United Kingdom. (Aug. 26, 2010) | |
| 92 | International Civil Aviation Organization, 999 University Street, Montreal, | 1 |
| | Quebec, H3C-5H7, CANADA. (Aug. 26, 2010) | |
| 93 | Sony Corp Of America, 550 Madison Ave, New York, NY 10022. (Aug. 26, 2010) | 1 |
| 94 | Sun Microsystems Inc, 4150 Network Circle, Santa Clara, CA 95054. (Aug. 26, 2010) | 1 |
| 95 | Sysco Corp, 1390 Enclave Pkwy, Houston, TX 77077. (Aug. 26, 2010) | 1 |
| 96 | Centers For Disease Control & Prevention, 1600 Clifton Road, Atlanta, GA | 1 |
| | 30333. (Aug. 26, 2010) | |
| 97 | National Agriculture Statistics Service, 1400 Independence Ave. SW, Washington, | 1 |
| | DC 20250. (Aug. 26, 2010) | |

The 97 organizations in the list that received David Bendah's Global Warming did not write David Bendah to agree or disagree with the hypothesis that David Bendah's Global Warming letter did indeed improve the climate and did lower the overall temperature and influenced other conditions, but only a few organizations did reply to David Bendah's Global Warming Letter.

David Bendah also contacted 47 law schools about his legal problems with the United States Postal Service and the mismanagement of his mail by the United States Postal Service. David Bendah's typed three versions of his U.S. Postal Service complaint, one version was 195 pages, the second legal brief version was 199 pages and the third legal brief version was 209 pages. David Bendah did include his Global Warming invention as well as the details of the principals and how his Global Warming invention worked in his U.S. Postal Service complaint. Here is a list of the Law schools that received David Bendah's Global Warming Letter that included the “Global Warming Letter” invention.

There was a different Global Warming effect when the David Bendah—United States Postal Service complaint was combined with David Bendah's Global Warming Letter. When the Postal Legal brief was combined with the Global Warming letter was an increase in Democracy, the free enterprise system and the American legal code.

The law schools that received David Bendah's Global Warming did not write David Bendah to agree or disagree with the hypothesis that David Bendah's Global Warming letter did indeed improve any conditions, the climate and did lower the overall temperature, but a few law schools did reply to David Bendah's request for legal aid by informing David Bendah by mail that they could not offer David Bendah any legal services. Not one law school in the United States or Canada offered to represent David Bendah in any legal matters.

A TABLE OF LAW SCHOOLS RECEIVING DAVID BENDAH'S 001-002-003 USPS COMPLAINT,
THAT INCLUDED THE PROCESS OF THE GLOBAL WARMING LETTER EFFECT.

| | | Delivered | Date |
|---|---|---|---|
| Num. | Law Firm Or Law School | Response | Mailed |
| 1 | University Of Toronto School Of Law Faculty Of Law, 78 Queen's | | Jan. 08, 2010 |
| | Park, Toronto, Ontario, CANADA, M5S 2C5. (001) & (003) | | Jun. 09, 2010 |
| 2 | Harvard Law School, 1563 Massachusetts Ave, Cambridge, MA 02138. | Jan. 28, 2010 | Jan. 08, 2010 |
| | (001) | | |
| 3 | Yale Law School, PO Box 208215, New Haven, CT 06520-8215. | | Jan. 13, 2010 |
| | (001). & (003) | | Jun. 09, 2010 |
| 4 | Columbia Law School, 435 W 116^{th} Street, New York, NY 10027 | Apr. 2, 2010 | Jan. 08, 2010 |
| | (001). | | |
| 5 | Stanford Law School, Crown Quadrangle, 559 Nathan Abbot Way, | Jun. 18, 2010 | Jan. 08, 2010 |
| | Stanford, CA 94305-8610. (001) & (003) | | Jun. 09, 2010 |
| 6 | New York University School Of Law, 40 Washington Square S, New | | Jan. 11, 2010 |
| | York, NY 10012. (001) & (003) | | Jun. 09, 2010 |
| 7 | University Of Chicago Law School, 111 E. 60^{th} Street, Chicago, IL | Jan. 23, 2010 | Jan. 11, 2010 |
| | 60637 (001). | | |
| 8 | Cornell Law School, Myron Taylor Hall, Ithaca, NY 14853-4901. | Jan. 26, 2010 | Jan. 11, 2010 |
| | (001). | | |
| 9 | Georgetown University Law Center, 600 New Jersey Avenue NW, | | Jan. 11, 2010 |
| | Washington, DC 20001-2075. (001). | | |
| 10 | Northwestern University School Of Law, 357 E. Chicago Ave, Chicago, | Feb. 18, 2010 | Jan. 11, 2010 |
| | IL 60611. (001). | | |
| 11 | UC Berkeley School Of Law, Boalt Hall, Berkeley, CA 94720-7200. | | Jan. 11, 2010 |
| | (001). | | |
| 12 | University Of Michigan Law School, 625 S. State Street, Ann Arbor, MI | Feb. 9, 2010 | Jan. 11, 2010 |
| | 48109-1215. (001). | | |
| 13 | University Of Pennsylvania Law School, 3400 Chestnut Street, | Feb. 1, 2010 | Jan. 11, 2010 |
| | Philadelphia, PA 19104-6204. (001). | | |
| 14 | University Of Virginia Law School, 580 Massie Road, Charlottesville, | | Jan. 11, 2010 |
| | VA 22903-1738. (001). | | |
| 15 | Duke University School Of Law, Towerview and Science Drive, Box | Jan. 22, 2010 | Jan. 13, 2010 |
| | 90362, Durham, NC 27708-0362. (001). | | |
| 16 | UCLA School Of Law, 71 Dodd Hall, PO Box 951445, Los Angeles, | | Jan. 13, 2010 |
| | CA 90095-1445. (001). | | |
| 17 | University Of Southern California Law School, 699 Exposition | Feb. 1, 2010 | Jan. 11, 2010 |
| | Boulevard, Los Angeles, CA 90089-0071. (001). | | |
| 18 | Vanderbilt University School Of Law, 131 21^{st} Avenue S, Nashville, TN | | Jan. 11, 2010 |
| | 37203-1181. (001). | | |
| 19 | Boston College Law School, 885 Center Street, Newton, MA 02459. | Jan. 23, 2010 | Jan. 11, 2010 |
| | (001). | | |
| 20 | Boston University School Of Law, 765 Commonwealth Avenue, Boston, | | Jan. 13, 2010 |
| | MA 02215. (001). | | |
| 21 | University Of Minnesota Law School, 229 19^{th} Avenue S, Minneapolis, | | Jan. 19, 2010 |
| | MN 55455. (001). | | |
| 22 | University Of Texas Law School, 727 Dean Keeton Street, Austin, TX | | Jan. 19, 2010 |
| | 78705-3299. (001). | | |
| 23 | Washington University - St. Louis Law School, 1 Brookings Drive, Box | | Jan. 19, 2010 |
| | 1120, St Louis, MO 63130. (001). | | |
| 24 | Emory University Law School, 1301 Clifton Road, Atlanta, GA 30322- | Jan. 25, 2010 | Jan. 19, 2010 |
| | 2770. (001). | | |
| 25 | Fordham University Law School, 140 W 62^{nd} Street, New York, NY | Mar. 4, 2010 | Jan. 19, 2010 |
| | 10023-7485. (001). | | |
| 26 | George Washington University Law School, 2000 H Street NW, | | Jan. 21, 2010 |
| | Washington, DC 20052. (002) | | |
| 27 | University Of Illinois College Of Law, 504 E Pennsylvania Avenue, | Apr. 5, 2010 | Jan. 21, 2010 |
| | Champaign, IL 61820. (002) | | |
| 28 | University Of Iowa College Of Law, 320 Melrose Avenue, Iowa City, | Feb. 12, 2010 | Jan. 21, 2010 |
| | IA 52242. (002) | | |
| 29 | University Of Wisconsin Law School, 975 Bascom Mall, Madison, WI | Jan. 30, 2010 | Jan. 21, 2010 |
| | 53706-1399. (002) | | |
| 30 | Washington & Lee University School Of Law, Sydney Lewis Hall, | | Jan. 21, 2010 |
| | Lexington, VA 24450-0303. (002) | | |
| 31 | Osgood Hall Law School, York University, 4700 Keele Street, Toronto, | | Jan. 22, 2010 |
| | Ontario, M3J-1P3, CANADA. (002) | | |
| 32 | George Mason School Of Law, 3301 Fairfax Drive, Arlington, VA | | Jan. 22, 2010 |
| | 22201-4426. (002) | | |
| 33 | Ohio State University Of Law, 55 W. 12^{th} Avenue, Columbus, OH | May 03, 2010 | Jan. 22, 2010 |
| | 43210. (002) | | |
| 34 | University Of Washington School Of Law, Campus Box 353020, | Feb. 16, 2010 | Jan. 26, 2010 |
| | Seattle, WA 98195-3020. (002) | | |
| 35 | Tulane School Of Law, 6329 Freret Street, John Giffen Weinmann Hall, | | Jan. 26, 2010 |
| | New Orleans, LA 70118-6231. (002) | | |
| 36 | UC Davis School Of Law, 400 Mrak Hall Drive, Davis, CA 95616- | | Jan. 26, 2010 |
| | 5201. (002) | | |
| 45 | United States Postal Service, 2101 Wilson Blvd., Suite 600, Arlington, | | Feb. 16, 2010 |
| | VA 22201. (002) Not long after mailing the Post Office Service a copy | | |
| | of the complaint, Bendah revised (002) to (003). | | |
| 37 | Faculty Of Law, McGill University, 3644 Peel Street, Montreal, Quebec, | Apr. 6, 2010 | Mar. 6, 2010 |
| | H3A 1W9, CANADA. (003) | | |
| 38 | UC Hastings College Of Law, 200 McAllister Street, San Francisco, CA | Apr. 15, 2010 | Mar. 6, 2010 |
| | 94102. (003) | | |
| 39 | University Of Georgia School Of Law, Herty Drive, Athens, GA 30602. | | Mar. 6, 2010 |
| | (003) | | |
| 40 | American University, Washington College Of Law, 4801 Massachusetts | | Mar. 6, 2010 |
| | Avenue, NW, Washington, DC 20016-8192. (003) | | |
| 41 | Baylor University Law School, 1114 S. University Parks Drive, 1 Bear | | Mar. 12, 2010 |
| | Place, Waco, TX 26798-7288. (003) | | |
| 42 | Indiana University School Of Law - Bloomington, 211 S. Indiana | | Mar. 12, 2010 |
| | Avenue, Bloomington, IN 47405-1001. (003) | | |
| 43 | University Of Arizona College Of Law, PO Box 210176, Tucson, AZ | | Mar. 12, 2010 |
| | 85721-0176. (003) | | |
| 44 | University Of Connecticut School Of Law, 55 Elizabeth Street, Hartford, | Mar. 19, 2010 | Mar. 12, 2010 |
| | CT 06105-2296. (003) | | |

(001) legal book = 195 pages,
(002) legal book = 199 pages,
(003) legal book = 209 pages.

### Operation

There is little difference between the effect of David Bendah's letter and a common air conditioner. David Bendah's invention is much cheaper to operate then an air conditioner system. An air conditioner or a freezing unit powered by refrigerants worked in similar manner as David Bendah's invention. Bendah's letter had an effect on liquids, solids and gases in the same way a machine would have on the temperature of a liquid, solid or a gas.

A machine that converts the temperature of a liquid, solid or gas had the exact same effect as David Bendah's global warming letter. David Bendah should be given a patent for his novel method of lowering the temperature and his novel method of reducing the incidence of disease and sickness as well as other effects. David Bendah used conditions of United States soldiers over the past 150 years as part of the focus of his email Global Warming letter. David Bendah used the American Vietnam Veteran and the American Panama Veterans and the American Civil War veterans as subjects of his invention to acquire a reduction in disease as well as a reduction in temperature.

### Geoengineering

The modern concept of geoengineering (or climate engineering) is usually taken to mean proposals to deliberately manipulate the Earth's climate to counteract the effects of global warming from greenhouse gas emissions. The National Academy of Sciences defined geoengineering as “options that would involve large-scale engineering of our environment in order to combat or counteract the effects of changes in atmospheric chemistry.” [1] IPCC (2007) concluded that geoengineering options, such as ocean fertilization to remove CO₂ from the atmosphere, remained largely unproven.[2] It was judged that reliable cost estimates for geoengineering had not yet been published.

Geoengineering accompanies mitigation and adaptation to form a 3-stranded ‘MAG’ approach to tackling global warming, notably advocated by the Institution of Mechanical Engineers.[3] Some geoengineering techniques are based on carbon sequestration. These techniques seek to reduce greenhouse gases in the atmosphere directly. These include direct methods (e.g. carbon dioxide air capture) and indirect methods (e.g. ocean iron fertilization). These techniques can be regarded as mitigation of global warming. Alternatively, solar radiation management techniques do not reduce greenhouse gas concentrations, and can only address the warming effects of carbon dioxide and other gases; they cannot address problems such as ocean acidification, which are expected as a result of rising carbon dioxide levels. Examples of proposed solar radiation management techniques include the production of stratospheric sulfur aerosols, which was suggested by Paul Crutzen,[4] space mirrors, and cloud reflectivity enhancement. Most techniques have at least some side effects.

To date, no large-scale geoengineering projects have been undertaken. Some limited tree planting [5] and cool roof [6] projects are already underway, and ocean iron fertilization is at an advanced stage of research, with small-scale research trials and global modelling having been completed.[7] Field research into sulfur aerosols has also started.[8] Some commentators have suggested that consideration of geoengineering presents a moral hazard because it threatens to reduce the political and popular pressure for emissions reduction.[9] Typically, the scientists and engineers proposing geoengineering strategies do not suggest that they are an alternative to emissions control, but rather an accompanying strategy.[10] Reviews of geoengineering techniques have emphasised that they are not substitutes for emission controls and have identified potentially stronger and weaker schemes. [11] [12] [13]

### Proposed Projects

Several geoengineering projects have been proposed. The documentaries Five ways to save the world and La temperature grimpe[27] describe many of the most notable projects. IPCC documents also detail several proposed projects.[28]

### Solar Radiation Management

Solar radiation management[29] (SRM) projects seek to reduce the amount of sunlight hitting the Earth and thus counteract global warming. They do not reduce greenhouse gas concentrations in the atmosphere, and thus do not address problems such as ocean acidification caused by these gases. The phenomenon of global dimming as a side-effect of fossil fuel use is widely known, and is not necessarily a geoengineering technique, also occurring naturally as a result of volcanoes and major forest fires. However, its deliberate manipulation is a tool of the geoengineer.

Solar radiation management projects often have the advantage of speed. While Greenhouse gas remediation offers a comprehensive possible solution to climate change, it does not give instant results; for that, solar radiation management is required.

Techniques that fall into this category include:
Creating stratospheric sulfur aerosols
Cool roof—using pale-coloured roofing and paving materials
Cloud reflectivity enhancement—using fine sea water spray to whiten clouds and increase cloud reflectivity.
Space sunshade—obstructing solar radiation with space-based mirrors or other structures
Cloud seeding of cirrus clouds, possibly using airliners.[30]

### Greenhouse Gas Remediation

Greenhouse gas remediation projects seek to remove greenhouse gases from the atmosphere, and thus tackle the root cause of global warming. They either directly remove greenhouse gases, or alternatively seek to influence natural processes to remove greenhouse gases indirectly. These projects offer a comprehensive solution to the problem of excess greenhouse gases in the atmosphere, but they will take many years to work fully. Many projects overlap with carbon capture and storage and carbon sequestration projects, and may not be considered to be geoengineering by all commentators. Techniques in this category include:
Ocean nourishment including Iron fertilization of the oceans
Creating biochar (anaerobic charcoal) and burying it to create terra preta
Bio-energy with carbon capture and storage
Carbon air capture to remove carbon dioxide from ambient air

### Arctic Geoengineering

Various hydrological geoengineering projects aim to change the climate without directly or indirectly removing greenhouse gases, or directly influencing solar radiation. These principally act by limiting Arctic sea ice loss. Keeping the Arctic ice is seen by many commentators as vital,[31] due to its role in the planet's albedo and in keeping methane, which is an important greenhouse gas, locked up in permafrost.[32]

### Heat Transport

The use of vertical ocean pipes to mix cooler deep water and warmer surface water has been proposed. This technology has also been suggested for the disruption of hurricanes by Bill Gates and others in a recent patent application.[33] [34] Modification of hurricanes may be considered weather modification rather than geoengineering, depending on the definition used.

From Wikipedia, the free encyclopedia. References to foot notes and hyperlinks are available at Wikipedia.

### Global Warming

Global warming is the increase in the average temperature of Earth's near-surface air and oceans since the mid-20th century and its projected continuation. According to the 2007 Fourth Assessment Report by the Intergovernmental Panel on Climate Change (IPCC), global surface temperature increased 0.74±0.18° C. (1.33±0.32° F.) during the 20th century.[2] [A] Most of the observed temperature increase since the middle of the 20th century was caused by increasing concentrations of greenhouse gases, which results from human activity such as the burning of fossil fuel and deforestation.[3] Global dimming, a result of increasing concentrations of atmospheric aerosols that block sunlight from reaching the surface, has partially countered the effects of greenhouse gas induced warming.

Climate model projections summarized in the latest IPCC report indicate that the global surface temperature is likely to rise a further 1.1 to 6.4° C. (2.0 to 11.5° F.) during the 21st century.[2]. The uncertainty in this estimate arises from the use of models with differing sensitivity to greenhouse gas concentrations and the use of differing estimates of future greenhouse gas emissions. An increase in global temperature will cause sea levels to rise and will change the amount and pattern of precipitation, probably including expansion of subtropical deserts.[4] Warming is expected to be strongest in the Arctic and would be associated with continuing retreat of glaciers, permafrost and sea ice. Other likely effects include changes in the frequency and intensity of extreme weather events, species extinctions, and changes in agricultural yields. Warming and related changes will vary from region to region around the globe, though the nature of these regional variations is uncertain.[5] Another major[6] [7] worldwide concomitant of global warming, and one which is presently happening as well as being predicted to continue, is ocean acidification, which is likewise a result of contemporary increases in atmospheric carbon dioxide.

The scientific consensus is that anthropogenic global warming is occurring.[8] [9] [10] [B] Nevertheless, political and public debate continues. The Kyoto Protocol is aimed at stabilizing greenhouse gas concentration to prevent a “dangerous anthropogenic interference”.[11] As of November 2009, 187 states have signed and ratified the protocol.[12

Evidence for warming of the climate system includes observed increases in global average air and ocean temperatures, widespread melting of snow and ice, and rising global average sea level.[13] [14] [15] [16] [17] The most common measure of global warming is the trend in globally averaged temperature near the Earth's surface. Expressed as a linear trend, this temperature rose by 0.74±0.18° C. over the period 1906-2005. The rate of warming over the last half of that period was almost double that for the period as a whole (0.13±0.03° C. per decade, versus 0.07° C.±0.02° C. per decade). The urban heat island effect is estimated to account for about 0.002° C. of warming per decade since 1900.[18] Temperatures in the lower troposphere have increased between 0.13 and 0.22° C. (0.22 and 0.4° F.) per decade since 1979, according to satellite temperature measurements. Temperature is believed to have been relatively stable over the one or two thousand years before 1850, with regionally varying fluctuations such as the Medieval Warm Period and the Little Ice Age.[19]

Estimates by NASA's Goddard Institute for Space Studies (GISS) and the National Climatic Data Center show that 2005 was the warmest year since reliable, widespread instrumental measurements became available in the late 1800s, exceeding the previous record set in 1998 by a few hundredths of a degree.[20] [21] Estimates prepared by the World Meteorological Organization and the Climatic Research Unit show 2005 as the second warmest year, behind 1998.[22] [23] Temperatures in 1998 were unusually warm because the strongest El Niño in the past century occurred during that year.[24] Global temperature is subject to short-term fluctuations that overlay long term trends and can temporarily mask them. The relative stability in temperature from 2002 to 2009 is consistent with such an episode.[25][26]

Temperature changes vary over the globe. Since 1979, land temperatures have increased about twice as fast as ocean temperatures (0.25° C. per decade against 0.13° C. per decade).[27] Ocean temperatures increase more slowly than land temperatures because of the larger effective heat capacity of the oceans and because the ocean loses more heat by evaporation.[28] The Northern Hemisphere warms faster than the Southern Hemisphere because it has more land and because it has extensive areas of seasonal snow and sea-ice cover subject to ice-albedo feedback. Although more greenhouse gases are emitted in the Northern than Southern Hemisphere this does not contribute to the difference in warming because the major greenhouse gases persist long enough to mix between hemispheres.[29]

The thermal inertia of the oceans and slow responses of other indirect effects mean that climate can take centuries or longer to adjust to changes in forcing. Climate commitment studies indicate that even if greenhouse gases were stabilized at 2000 levels, a further warming of about 0.5° C. (0.9° F.) would still occur.[30]

From Wikipedia, the free encyclopedia. References to foot notes and hyperlinks are available at Wikipedia.

### Weather Control and Law

Weather control is the act of manipulating or altering certain aspects of the environment to produce desirable changes in weather. Weather control can have the goal of preventing damaging weather, such as hurricanes or tornadoes, from occurring; of causing beneficial weather, such as rainfall in an area experiencing drought; or of provoking damaging weather against an enemy or rival, as a tactic of military or economic warfare. Weather modification in warfare has been banned by the United Nations.

### Cloud Seeding as an Example of Weather Control

Cloud seeding is a common technique to enhance precipitation, and evidence on its effectiveness and safety is strong.[6] [dubious—discuss] Because of the public's ever-growing need for more water, there has also been a rapid development of water and hydropower utilities that devote resources to cloud seeding. Critics generally contend that claimed successes occur in conditions which were going to rain anyway. It is used in a variety of drought-prone countries, including the United States, the People's Republic of China, India, and Russia. In the People's Republic of China there is a perceived dependency upon it in dry regions. In the United States, dry ice or silver iodide may be injected into a cloud by aircraft, or from the ground. In mountainous areas of the United States such as the Rocky Mountains and Sierra Nevada,[7] it has been employed for several decades.

### Weather Control and Law

### US and Canada Agreement

In 1975, the US and Canada entered into an agreement under the auspices of the United Nations for the exchange of information on weather modification activity.[17]

### 1977 UN Environmental Modification Convention

Weather control, particularly hostile weather warfare, was addressed by the “United Nations General Assembly Resolution 31/72, TIAS 9614 Convention[18] on the Prohibition of Military or Any Other Hostile Use of Environmental Modification Techniques” was adopted. The Convention was: Signed in Geneva May 18, 1977; Entered into force Oct. 5, 1978; Ratification by U.S. President Dec. 13, 1979; U.S. ratification deposited at New York Jan. 17, 1980.[19]

### US National Oceanic and Atmospheric Administration

In the US, the National Oceanic and Atmospheric Administration regulates weather control projects, under authority of Public Law 205 of the 92nd Congress.

### US Legislation

The Space Preservation Act was proposed “to preserve the cooperative, peaceful uses of space for the benefit of all humankind by permanently prohibiting the basing of weapons in space by the United States, and to require the President to take action to adopt and implement a world treaty banning space-based weapons.”[20]

2005 U.S. Senate Bill 517 and U.S. House Bill 2995 U.S. Senate Bill 517[21] and U.S. House Bill 2995[22] were two bills proposed in 2005 that would have expanded experimental weather modification, to establish a Weather Modification Operations and Research Board, and implemented a national weather modification policy. Neither were made into law. Former Texas State Senator John N. Leedom was the key lobbyist on behalf of the weather modification bills.

2007 U.S. Senate Bill 1807 & U.S. House Bill 3445 Senate Bill 1807 and House Bill 3445, identical bills introduced Jul. 17, 2007, proposed to establish a Weather Mitigation Advisory and Research Board to fund weather modification research [23] [24]

Future Aspirations Of Weather Control

Climatologist Joe Chanik has simulated hurricane control based on selective heating and cooling (or prevention of evaporation).[25] Futurist John Smart has discussed the potential for weather control via space-based solar power networks. One proposal involves the gentle heating via microwave of portions of large hurricanes. Such chaotic systems may be susceptible to “side steering” with a few degrees of increased temperature/pressure at critical points. A sufficient network might keep the largest and most potentially damaging hurricanes from landfall, at the request of host nations. Blizzards, monsoons, and other extreme weather are also potential candidates for space-based amelioration.[citation needed] If large-scale weather control were to become feasible, potential implications may include:
Unintended side effects, especially given the chaotic nature of weather development
Damage to existing ecosystems
Health risks to humans
Equipment malfunction or accidents
Non-democratic control or use as a weapon
ELF hot spots causing slightly accelerated ionospheric depletion by solar wind [26]

For the 2008 Olympics, China had 30 airplanes, 4,000 rocket launchers, and 7,000 anti-aircraft guns to stop rain. Each system would shoot various chemicals into any threatening clouds to shrink rain drops before they reach the stadium.[27]

From Wikipedia, the free encyclopedia. References to foot notes and hyperlinks are available at Wikipedia.

### Geoengineering Risks

### Geoengineering Implementation Issues

There is no general consensus that geoengineering is safe, appropriate or effective, for the reasons listed above. The issue of moral hazard means that many environmental groups and campaigners are reluctant to advocate geoengineering for fear of reducing the imperative to cut greenhouse gas emissions.^{[86]} Other environmentalists see calls for geoengineering as part of an explicit strategy to delay emissions reductions on the part of those with connections to coal and oil industries^{[87]}.

All proposed geoengineering techniques require implementation on a relatively large scale, in order to make a significant difference to the Earth's climate. The least costly schemes are budgeted at a cost of millions,^{[88]} with many more complex schemes such as space sunshade costing far more.

Many techniques, again such as space sunshade, require a complex technical development process before they are ready to be implemented. There is no clear institutional mechanism for handling this research and development process. As a result, many promising techniques do not have the engineering development or experimental evidence to determine their feasibility or efficacy at present.

Once a technique has been developed and tested, its implementation is still likely to be difficult. Climate change is by nature a global problem, and therefore no one institution, company or government is responsible for it. The substantial costs of most geoengineering techniques therefore cannot currently be apportioned. Roll-out of such technologies is therefore likely to be delayed until these issues can be resolved. A notable exception is the use of small albedo manipulation projects, known as cool roof in which the colour of roofing or paving surfaces can be manipulated to reflect solar radiation back into space. These can be, and are, implemented by individuals, companies and governments without controversy.^{[89]}

Due to the radical changes caused by geoengineering interventions, legal issues are also an impediment to implementation. The changes resulting from geoengineering necessarily benefit some people and disadvantage others. There may therefore be legal challenges to the implementation of geoengineering techniques by those adversely affected by them.^{[90]}

### Evaluation of Geoengineering

Few field experiments in geoengineering have been carried out. Most of what is known about the suggested techniques is based on small-scale trials and from simulations of global climate models and other computer modelling techniques. Some geoengineering schemes employ methods that have analogues in natural phenomena such as stratospheric sulfur aerosols and cloud condensation nuclei. As such, studies about the efficacy of these schemes can draw on information already available from other research, such as that following the 1991 eruption of Mount Pinatubo. However, comparative evaluation of the relative merits of each technology is complicated, especially given modelling uncertainties and the early stage of engineering development of many geoengineering schemes.^{[91]}

In a 2009 review study, Lenton and Vaughan evaluated a range of geoengineering schemes from those that sequester CO₂ from the atmosphere and decrease longwave radiation trapping, to those that decrease the Earth's receipt of shortwave radiation.^{[11]} In order to permit a comparison of disparate techniques, they used a common evaluation for each scheme based on its effect on net radiative forcing. As such, the review examined the scientific plausibility of schemes rather than the practical considerations such as engineering feasibility or economic cost. Lenton and Vaughan found that “[air] capture and storage shows the greatest potential, combined with afforestation, reforestation and bio-char production”, and noted that “other suggestions that have received considerable media attention, in particular “ocean pipes” appear to be ineffective”.^{[11]} They concluded that “[climate] geoengineering is best considered as a potential complement to the mitigation of CO₂ emissions, rather than as an alternative to it”.^{[11]}

Reports into geoengineering have also been published in the United Kingdom by the Institution of Mechanical Engineers^{[12]} and the Royal Society.^{[13]} The IMechE report examined a small subset of proposed schemes (air capture, urban albedo and algal-based CO₂ capture schemes), and its main conclusions were that geoengineering should be researched and trialled at the small scale alongside a wider decarbonisation of the economy.^{[12]}

The Royal Society review examined a wide range of geoengineering schemes and evaluated them in terms of effectiveness, affordability, timeliness and safety (assigning qualitative estimates in each assessment). Similarly to Lenton and Vaughan,^{[11]} the report divided schemes into “carbon dioxide removal” (CDR) and “solar radiation management” (SRM) approaches that respectively address longwave and shortwave radiation. The key recommendations of the report were that “Parties to the UNFCCC should make increased efforts towards mitigating and adapting to climate change, and in particular to agreeing to global emissions reductions”, and that “[nothing] now known about geoengineering options gives any reason to diminish these efforts”.^{[13]} Nonetheless, the report also recommended that “research and development of geoengineering options should be undertaken to investigate whether low risk methods can be made available if it becomes necessary to reduce the rate of warming this century”.^{[13]}

From Wikipedia, the free encyclopedia. References to foot notes and hyperlinks are available at Wikipedia.

### Newspaper Articles

Newspaper articles that may or may not involve geoengineering.

2003 Heat Wave—from Wikipedia

The 2003 European heat wave is one of the hottest summers on record in Europe, especially in France. The heat wave led to health crises in several countries and combined drought to create crop shortfall in Southern Europe. More then seventy thousand (70,000) Europeans died as a result of the heat wave. In France there were 14,802 heat-related deaths (mostly among the elderly) during the heat wave, according the French National Institute Of Health.

2003 Heat Wave Effects on Crops—The following shortfalls in wheat harvest occurred as a result of the long European drought.
France—20%
Italy—13%
United Kingdom—12%
Ukraine—75% (Unknown if affected by heat wave or an early freeze that year.)
Moldova—80%
   Snow Storm could Dump 30 Inches on Washington Area. Feb. 5, 2010

WASHINGTON—Shoppers jammed aisles and emptied stores of milk, bread and shovels ahead of a monster snow storm bearing down Friday on the Mid-Atlantic with 30 inches or more forecast for the Nation's capitol. The Federal government send workers home early and subways ran light as people stayed home.

The region's second snow storm in less than two months could be “extremely dangerous” the National Weather Service said. Heavy wet snow and strong winds would make travel hazardous as the storm gains strength into Friday night. One fatality involved a tractor-trailer had already been reported as of 1 p.m. EST.

### Dallas Snow Record—Feb. 12, 2010

Nearly 500,000 Dallas school kids had an additional holiday to enjoy following record breaking flurry in a span of 24 hours. 12.5 inches snow had already been recorded therefore it is likely the record may be bettered even further. Thousands of electric outage complaints were registered in the Fort Worth Dallas areas.

### Europe Disrupted by Snow—Dec. 21, 2009

Record low temperature thick snow and packed, impassable roads. Despite the fact that winter hasn't officially started yet, Europe was paralyzed by bitterly cold weather this weekend. A summary.

In Amsterdam, some people were using skis to get around this weekend, children had gone to the attic to get their sledges and snowmen popped up throughout the Netherlands. The onset of winter brought with it fund and lots of beautiful views. However between 10 to 23 centimeters of snow fell throughout the country and this was enough to disrupt daily life.

### Hundreds Die in Indian Heatwave—Sunday May 30, 2010

Death toll expected to rise as India faces record temperatures of up to 122 F in hottest summer on record. Record temperatures in northern India have claimed hundreds of lives in what is believed to be the hottest summer in the country since records began in the late 1800's.

### Heavy Snow Storms in Northern China Kill 40—Nov. 14, 2009

Beijing—Unusually early snow storms in north-central China have claimed 40 lives, caused thousands of buildings to collapse and destroyed almost 500,000 acres of winter crops. The snow fall is the heaviest in the Hebei, Shanxi, Shaanxi, Shandong and Henan since record keeping began.

Chinese state media say some of the snow was induced through cloud seeding, although the precise amount of snow fall in all areas was not reported as it wasn't clear what the previous records were.

1995 Chicago Heat Wave—from Wikipedia

The 1995 Chicago heat wave was a heat wave which led to approximately 700 heat-related deaths in Chicago over a period of five days. Eric Klineberg, author of the 2002 book Heat Wave: A Social Autopsy of Disaster In Chicago, has noted that in the United States, the loss of human life in hot spells in summer exceeds that caused by all other weather events combined including lightning, rain, floods, hurricanes and tornadoes.

### Earth May be Too Hot for Humans by 2300: Study—May 12, 2010

SYDNEY (AFB)—Climate change could make much of the world too hot for human habitation within just three centuries, research released Tuesday showed.

Scientists for Australia's University of New South Wales and Purdue University in the United States found that rising temperatures in some places could mean humans would be unable to adapt or survive. “It would begin to occur with global-mean warming of about seven degrees Celsius (13 Fahrenheit), calling the habitability of some regions in question.” The researchers said in a paper.

1. A Decrease In Temperature.
A mechanism that involves a process that decreases the temperature so that the temperature is colder.

2. A Reduction In Humidity.
A mechanism that involves a process that causes a reduction water vapor in the air. A mechanism that involves a process that causes a reduction of water vapor in the soil.

3. A Reduction In Disease
A mechanism that involves a process that causes a reduction in disease.
